(19) United States
(12) Patent Application Publication
(10) Pub. No.: US 2025/0387752 A1
(43) Pub. Date: Dec. 25, 2025

(54) Split Acid-Base Streams to Improve AWL and Other Carbon Capture Reactors

(71) Applicant: Calcarea, Inc., Los Angeles, CA (US)

(72) Inventors: Jess Firey Adkins, Altadena, CA (US); Pierre Forin, Los Angeles, CA (US); Melissa Gutierrez, Los Angeles, CA (US)

(73) Assignee: Calcarea, Inc., Los Angeles, CA (US)

(21) Appl. No.: 19/249,781

(22) Filed: Jun. 25, 2025

Related U.S. Application Data
(60) Provisional application No. 63/664,040, filed on Jun. 25, 2024.

(51) Int. Cl. B01D 53/62; B01D 53/14; B01D 53/18; B01D 53/78

(52) U.S. Cl. CPC B01D 53/62; B01D 53/1475; B01D 53/1493; B01D 53/18; B01D 53/78; B01D 2251/404; B01D 2251/606; B01D 2252/1035; B01D 2257/504

(57) ABSTRACT

A reactor for enhanced and scalable CO₂ sequestration and storage in water with neutral or near neutral pH outflow is described, along with a method of use thereof. The reactor and method are an AWL reactor and method that additionally employ an acid to enhance CO₂ hydration kinetics, and, as such, the conversion of CO₂ to bicarbonate ions for storage. In addition, the reactor and method employ a base, in an amount equimolar to the acid's amount, to directly capture any un-titrated aqueous CO₂, and, as such, to convert even more CO₂ to bicarbonate ions for robust storage, and also to neutralize the otherwise over-acidified effluent water stream being returned to the environment from the reactor.

### CROSS-REFERENCE TO RELATED APPLICATIONS

The current application claims the benefit of and priority under 35 U.S.C. § 119 (e) to U.S. Provisional Patent Application No. 63/664,040, entitled “Split Acid-Base Streams to Improve Awl and Other Carbon Capture Reactors”, filed Jun. 25, 2024, the disclosure of which is incorporated herein by reference in its entirety for all purposes.

### FIELD OF THE INVENTION

The current disclosure is directed to reactors and methods for enhanced and scalable CO₂ sequestration and storage in water, wherein the reactors are characterized by neutral or near neutral pH outflow.

### BACKGROUND OF THE INVENTION

Carbon dioxide (CO₂) constitutes about 0.04% (400 parts per million) of the atmosphere. Despite its relatively small overall concentration, CO₂ is a potent greenhouse gas that plays an important role in regulating the Earth's surface temperature. Presently, anthropogenic CO₂ generation is taking place at a rate greater than it is being consumed and/or stored, leading to increasing concentrations of CO₂ in the atmosphere. There is a growing concern that rising levels of CO₂ in the earth's atmosphere may present a substantial environmental challenge. As a result, there is an increased interest in developing methods for removing CO₂ from emission streams and the atmosphere, and storing it in a manner that prevents its future release into the atmosphere. This capture and storage are collectively known as CO₂ sequestration.

As such, carbon capture and storage (CCS) efforts have long been centered on Earth's atmosphere, with companies scrubbing carbon dioxide from the air and storing it underground. However, while effective, the currently utilized CCS methods are energy intensive and, thus, expensive. Accordingly, there exists a great and urgent need for effective and sustainable, yet inexpensive, CCS approaches.

### SUMMARY OF THE INVENTION

Various embodiments are directed to a reactor for CO₂ sequestration and storage in water, characterized by a neutral or near neutral pH outflow, at least including:
a first chamber including:
   a reaction medium solid;
   a gas inlet for delivering a gas stream including a CO₂ amount of CO₂ gas to the first chamber;
   a water inlet for delivering a feedstock water characterized by a feedstock pH to the first chamber;
   an acid inlet for delivering an acid amount of an acid to the first chamber;
   a gas outlet for releasing an effluent gas from the first chamber; and
   a first effluent outlet for releasing a first effluent, wherein the first effluent is the first chamber's liquid effluent; and
a second chamber, in fluid communication with the first chamber, wherein the second chamber at least includes:
   an effluent inlet, in fluid communication with the first effluent outlet for delivering the first effluent to the second chamber;
   a base inlet for delivering a base amount of a base to the second chamber; wherein the base amount is equimolar to the acid amount, and
   a second effluent outlet for release of a second effluent, wherein the second effluent is the second chamber's and the reactor's liquid effluent

In various such embodiments, the first chamber is a fluidized bed reactor, and the first chamber further includes a reaction medium solid inlet for delivering the reaction medium solid to the first chamber.

In still various such embodiments, the first chamber further includes a CO₂ absorption sub-chamber and a CO₂ conversion sub-chamber connected in series via a connector for separate CO₂ absorption and conversion to bicarbonate.

In still yet various embodiments,
the CO₂ absorption sub-chamber at least includes:
   an implement for contacting gas and liquid phases,
   the gas inlet,
   the water inlet,
   the gas outlet,
   optionally, the acid inlet, and
   an absorption effluent outlet for release of a CO₂-enriched water from the CO₂ absorption sub-chamber;
the CO₂ conversion sub-chamber at least includes:
   the reaction medium solid,
   an absorption effluent inlet in fluid communication with the absorption effluent outlet of the CO₂ absorption sub-chamber, and
   the first effluent outlet; and
the connector at least includes the acid inlet.

In yet still various such embodiments, the first chamber is a packed column reactor including: one or more packed columns connected in parallel, wherein each packed column is the CO₂ conversion sub-chamber; the CO₂ absorption sub-chamber; and a connector providing a fluid communication between the CO₂ absorption sub-chamber and each of the one or more packed columns.

In yet various such embodiments the feedstock water is water selected from the group consisting of: seawater, freshwater; and any combination thereof.

In various such embodiments the acid is selected from the group consisting of: a proton and an acid with pKa of <2.

In still various such embodiments, the acid is selected from the group consisting of: HCl, H₂SO₄, and any combination thereof.

In yet still various such embodiments, the base is selected from the group consisting of: an OH ion and a base with pkb of >11.

In still yet various such embodiments, the base is selected from the group consisting of: NaOH, KOH, and any combination thereof.

In yet various such embodiments, the acid is a proton, the base is a hydroxide ion, and the acid amount and the base amount are obtained and delivered to the first and the second chambers, correspondingly, form a water splitting process, wherein the water splitting process splits water into hydrogen and hydroxide ions.

In various such embodiments, the acid amount and the base amount are up to 10% of the CO₂ amount.

In still various such embodiments, the reaction medium solid includes a material or reagent selected from the group consisting of: CaO; limestone and its various forms, including aragonite, calcite and vaterite; dolomite, Na₂CO₃, another carbonate; NaHCO₃; MgSiO₃, olivine, pyroxene, mafic rock; another silicate; another material capable of sequestering CO₂; and any combination thereof.

Various other embodiments are directed to a method for CO₂ sequestration and storage in water, characterized by a neutral or near neutral pH outflow, including: providing a reactor at least including:
a first chamber including:
   a reaction medium solid;
   a gas inlet for delivering a gas stream including a CO₂ amount of CO₂ gas to the first chamber;
   a water inlet for delivering a feedstock water characterized by a feedstock pH to the first chamber;
   an acid inlet for delivering an acid amount of an acid to the first chamber;
   a gas outlet for releasing an effluent gas from the first chamber; and
   a first effluent outlet for releasing a first effluent, wherein the first effluent is the first chamber's liquid effluent; and
a second chamber, in fluid communication with the first chamber, wherein the second chamber at least includes:
   an effluent inlet, in fluid communication with the first effluent outlet for delivering the first effluent to the second chamber;
   a base inlet for delivering a base amount of a base to the second chamber;
      wherein the base amount is equimolar to the acid amount, and
   a second effluent outlet for release of a second effluent, wherein the second effluent is the second chamber's and the reactor's liquid effluent characterized by an effluent pH;
providing and delivering to the first chamber the gas stream, the feedstock water, and the acid;
providing and delivering to the second chamber the base; and replenishing the reaction medium solid as needed; and
flowing the feedstock water through the first chamber and the second chamber sequentially
   to sequester and store CO₂ from the gas stream as bicarbonate ion, wherein the bicarbonate ion is released into the environment with the reactor's liquid effluent, and wherein the effluent pH is equal or near equal to the feedstock pH.

In various such embodiments, the first chamber is a fluidized bed reactor, and the first chamber further includes a reaction medium solid inlet for delivering the reaction medium solid to the first chamber.

In still various such embodiments, the first chamber further includes a CO₂ absorption sub-chamber and a CO₂ conversion sub-chamber connected in series via a connector for separate CO₂ absorption and conversion to bicarbonate.

In still yet various embodiments,
the CO₂ absorption sub-chamber at least includes:
   an implement for contacting gas and liquid phases,
   the gas inlet,
   the water inlet,
   the gas outlet,
   optionally, the acid inlet, and
   an absorption effluent outlet for release of a CO₂-enriched water from the CO₂ absorption sub-chamber;
the CO₂ conversion sub-chamber at least includes:
   the reaction medium solid,
   an absorption effluent inlet in fluid communication with the absorption effluent outlet of the CO₂ absorption sub-chamber, and
   the first effluent outlet; and
   the connector at least includes the acid inlet.

In yet still various such embodiments, the first chamber is a packed column reactor including: one or more packed columns connected in parallel, wherein each packed column is the CO₂ conversion sub-chamber; the CO₂ absorption sub-chamber; and a connector providing a fluid communication between the CO₂ absorption sub-chamber and each of the one or more packed columns.

In yet various such embodiments, the feedstock water is selected from the group consisting of: seawater, freshwater, and any combination thereof.

In various such embodiments, the acid is selected from the group consisting of: a proton and an acid with pKa of <2.

In still various such embodiments, the base is selected from the group consisting of: an OH ion and a base with pkb of >11.

In yet still various such embodiments, the acid is a proton, the base is a hydroxide ion, and the acid amount and the base amount are obtained and delivered to the first and the second chambers, correspondingly, form a water splitting process, wherein the water splitting process splits water into hydrogen and hydroxide ions.

In still yet various such embodiments, the acid amount and the base amount are up to 10% of the CO₂ amount.

In yet various such embodiments, the reaction medium solid includes a material or reagent selected from the group consisting of: CaO; limestone and its various forms, including aragonite, calcite and vaterite; dolomite, Na₂CO₃, another carbonate; NaHCO₃; MgSiO₃, olivine, pyroxene, mafic rock; another silicate; another material capable of sequestering CO₂; and any combination thereof.

Still various other embodiments are directed to a marine vessel capable of CO₂ sequestration and storage in water and characterized by a neutral or near neutral pH outflow, including:
a reactor at least including:
a first chamber including:
   a reaction medium solid;
   a gas inlet for delivering a gas stream including a CO₂ amount of CO₂ gas to the first chamber;
   a water inlet for delivering a feedstock water characterized by a feedstock pH to the first chamber;
   an acid inlet for delivering an acid amount of an acid to the first chamber;
   a gas outlet for releasing an effluent gas from the first chamber; and
   a first effluent outlet for releasing a first effluent, wherein the first effluent is the first chamber's liquid effluent; and
a second chamber, in fluid communication with the first chamber, wherein the second chamber at least includes:
   an effluent inlet, in fluid communication with the first effluent outlet for delivering the first effluent to the second chamber;
   a base inlet for delivering a base amount of a base to the second chamber;
      wherein the base amount is equimolar to the acid amount, and
   a second effluent outlet for release of a second effluent, wherein the second effluent is the second chamber's and the reactor's liquid effluent.

In various such embodiments, a movement of the marine vessel across a body of water facilitates and promotes flowing of the feedstock water through the reactor, such that the marine vessel serves as a water pump.

Additional embodiments and features are set forth in part in the description that follows, and in part will become apparent to those skilled in the art upon examination of the specification or may be learned by the practice of the disclosed subject matter. A further understanding of the nature and advantages of the present disclosure may be realized by reference to the remaining portions of the specification and the drawings, which forms a part of this disclosure.

### BRIEF DESCRIPTION OF THE DRAWINGS

These and other features and advantages of the present invention will be better understood by reference to the following detailed description when considered in conjunction with the accompanying data and figures, wherein:

FIG. 1 provides plots showing the dependency of the speed of CO₂ hydration rate on pH at different temperatures, wherein each plot line represents a different temperature, according to prior art.

FIGS. 2A and 2B provide schematic illustrations of various designs of the reactor, wherein FIG. 2A illustrates the reactor design wherein the reactor comprises two chambers—an acid-assisted treatment first chamber (left), wherein the first chamber is a fluidized bed reactor; and a base treatment second chamber (right); while FIG. 2B illustrates the rector design wherein the acid-assisted treatment first chamber of the reactor is split into an absorber and a converter sub-chambers, which are followed by a base treatment second chamber, in accordance with embodiments of the application.

FIG. 3 provides plots comparing time dependent alkalinity (left panel) and pH (right panel) results obtained from lab experiments (x-traces) and computational modeling (o-traces) for the reactor modification relying on a single-stage fluidized bed as the reaction medium's solids, gas, and liquid container, in accordance with embodiments of the application.

FIG. 4 provides a modeled analysis of the reactor effluent's pH sensitivity towards addition of a base to the effluent leaving the first chamber, wherein pH of the overall reactor's effluent (y-axis) is plotted against the rate of alkalinity production by the first chamber (x-axis), and wherein the individual dots represent various second chamber base addition rates, with the bottom dots representing zero base addition and the top dots representing the most base added, in accordance with embodiments of the application.

### DETAILED DISCLOSURE

The embodiments of the invention described herein are not intended to be exhaustive or to limit the invention to precise forms disclosed. Rather, the embodiments selected for description have been chosen to enable one skilled in the art to practice the invention.

Turning to the drawings, schemes, and data, embodiments of a reactor for efficient CO₂ sequestration and storage in water, wherein the reactor is characterized by neutral or near neutral pH outflow, as well as a method of use thereof, are provided. In many embodiments, the reactor and method rely on an accelerated weathering of limestone (AWL)-type processes. In many such embodiments, the reactor and method employ an addition of an acid amount of an acid to enhance CO₂ hydration kinetics, and, as such, to afford more efficient conversion of CO₂ to bicarbonate ions for storage. In addition, in many such embodiments, the reactor and method also employ an addition of a base amount of a base, wherein the base amount is equal to the acid amount, to directly capture the aqueous CO₂ that has escaped the acid-assisted treatment, and, as such, to neutralize an otherwise over-acidified effluent water stream leaving the reactor and being returned to the environment.

A conventional AWL process/reactor uptakes CO₂ gas and reacts it with CaCO₃ (commonly known as limestone) in water (often seawater) according to, most generally, the reaction equation:

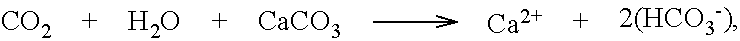 [SMILES: "CO2" ; O ; "CaCO3" ; [Ca+2]]

which results in safe and permanent storage of anthropogenic carbon in the ocean as bicarbonate ions. This is the natural buffering process, sometimes called ‘carbonate compensation’, that regulates earth's CO₂ concentration in the atmosphere. However, this process is constrained by 2 rate limiting steps—CO₂ gas adsorption and limestone solids dissolution. More specifically, since AWL processes typically rely on an oversupply of CO₂ as compared to ambient air (i.e., a partial pressure of CO₂ gas (pCO₂) higher than the ambient levels of CO₂), CO₂ gas adsorption by an AWL reactor's reaction medium is often faster than the dissolution of that reactor's reaction medium's solids (e.g., limestone), resulting in an incomplete titration of the incoming CO₂ to bicarbonate HCO₃⁻, and, as such, in the effluent (i.e., the water leaving the reactor) being more acidic than the incoming feedstock water (often ambient seawater). Accordingly, although the unreacted CO₂ gas dissolved in an AWL reaction medium is still being stored away from the atmosphere as hydrated/aqueous CO₂, and, as such, it no longer contributes to the warming of the earth, the aqueous CO₂ may reside in the ocean for shorter timescales than when fully converted to the bicarbonate form.

One reason behind the slow dissolution rate of solid limestone is the limiting reaction kinetics of CO₂ hydration reaction. More specifically, aqueous CO₂ needs to add a water molecule to become carbonic acid (H₂CO₃), as follows:

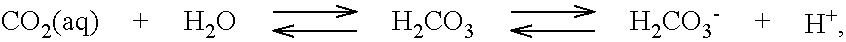

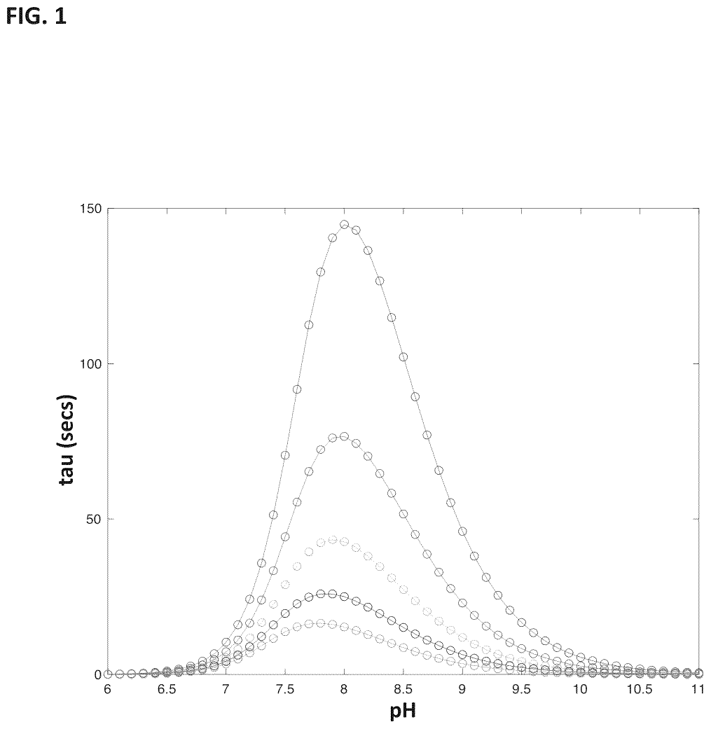

after which step the equilibrium between the dissolved inorganic carbon (DIC) species, i.e., carbonate ion (CO₃²⁺), bicarbonate ion (HCO₃⁻), and carbonic acid (H₂CO₃), occurs very quickly. Nevertheless, the slow step in the full equilibration of this process with CO₂ gas is the CO₂ hydration reaction to H₂CO₃, wherein the CO₂ hydration rate is a strong function of pH, as discussed in Zeebe, R. E. and Wolf-Gladrow, D. (2001) “CO₂ in Seawater: Equilibrium, Kinetics, Isotopes,” Elsevier Oceanography Series, the disclosure of which is incorporated herein by reference, and also illustrated by FIG. 1.

Furthermore, there are two elementary reaction pathways to convert CO₂ aqueous into its hydrated form—hydration (Equation 1) and hydroxylation (Equation 2):

$${CO}_{2} ( a q ) + {H}_{2} O ⇄ \begin{matrix}{{K}_{+ 1}}^{} \\ {{K}_{- 1}}_{}\end{matrix} H C {O}_{3}^{-} + {H}^{+} \qquad Eq . ( 1 )$$

$${CO}_{2} ( a q ) + O {H}^{-} ⇄ \begin{matrix}{{K}_{+ 2}}^{} \\ {{K}_{- 2}}_{}\end{matrix} H C {O}_{3}^{-} \qquad Eq . ( 2 )$$

$$1 / τ = ( {k}_{+ 1} + {k}_{- 1} [ {H}^{+} ] + {k}_{- 4} + {k}_{+ 4} [ O {H}^{-} ] ) \qquad Eq . ( 3 )$$

Here, the ‘tau’ value in Equation (3) is the time it takes a new addition of CO₂(aq) to the system to move 1/e of the way towards a new equilibrium distribution of all the DIC species. As such, at acidic pH values, the overall reaction is fast because the reaction of Equation (1) is the main pathway and protons increase the right-hand side of Equation (3). On the other hand, at basic values, the reaction is also fast because hydroxyl ions are abundant and promote the reaction of Equation (2), making the right-hand side of Equation (3) large as well. However, at around pH 8, which is, notably, the typical pH of seawater, the reaction is at its slowest (FIG. 1).

Moreover, AWL and other carbon capture reactors can have residence times ranging from a few tens of seconds to a few minutes, wherein a residence time, as used herein, is the ratio of the reactor's volume to the water flow rate/transport in volume/time. These values are short compared to CO₂ hydration kinetics (as seen in FIG. 1), and, therefore, keep the CO₂ gas that has dissolved in the reactor's water (i.e., CO₂ aqueous) from being able to hydrate, such as to use the resulting acidity to dissolve CaCO₃ at the fastest possible rates. Notably, an addition of extra acid to an AWL system will promote faster kinetics and more storage of carbon as bicarbonate ions, however, such additional acidity will also retard the adsorption of CO₂ gas into the reactor's water in the first place. Accordingly, for each AWL reactor/set-up there exists an optimal amount of acid to be added to promote that reactor's performance. Nevertheless, it should also be noted here, that if an AWL reactor is to work at scale to remove CO₂ from point sources, or from the environment in general, the overall process can't net consume acid (or base), because the size of the CO₂ mitigation problem is too large to allow other species, besides the safe reaction products, to build up during the CO₂ removal process.

This application is directed to embodiments of a reactor for efficient and scalable CO₂ sequestration and storage in water and a method of use thereof. In particular, the application is directed to embodiments of a reactor and method for efficiently storing CO₂ in water as bicarbonate ions, wherein the effluent leaving the reactor post-treatment is characterized by a neutral or near neutral pH and, thus, is safe for the environment. In many embodiments, the water is seawater, however, in some embodiments, the water is freshwater, while in still other embodiments, the water is a combination of seawater and freshwater. In some embodiments, CO₂ is stored as CO₂(aq)/H₂CO₃, in addition to bicarbonate ions. In many embodiments, the reactor is an AWL reactor. In many embodiments, the method relies on using equimolar additions of acid and base to different parts of the reactor employed in the method, such that there is no net acid or base build up during the CO₂ sequestration process. Accordingly, in many embodiments, the reactor comprises at least two chambers: a first chamber for CO₂ gas adsorption and acid-enhanced conversion to robustly store CO₂ in water as bicarbonate ions; and a second chamber, in fluid communication with the first chamber, for base-facilitated conversion and storage of un-titrated aqueous CO₂ escaping the first chamber, also as bicarbonate ions, and, as such, for ensuring neutral or near neutral pH of the effluent leaving the reactor. In some embodiments, the first chamber is further divided into separated, but interconnected, sub-chambers for CO₂ gas absorption and CO₂ conversion to bicarbonate. In many such embodiments, the acid is added to the effluent entering the CO₂ conversion sub-chamber for acid-enhanced CO₂ conversion to bicarbonate.

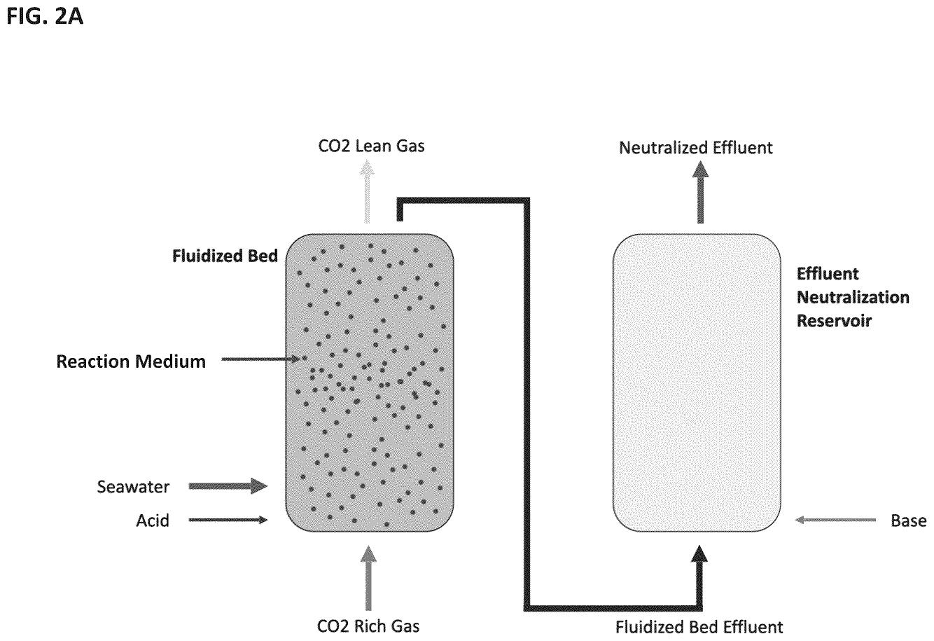

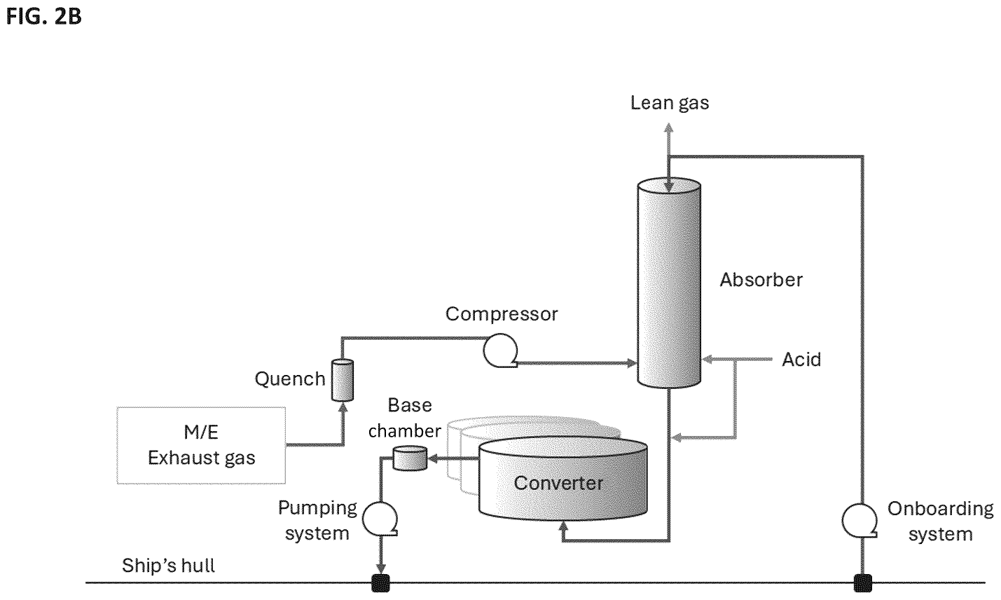

More specifically, in many embodiments, illustrated by FIG. 2A, the first chamber at least comprises: a reaction medium solid; a gas inlet for delivering a CO₂-rich gas stream (e.g., a marine vessel's flue gas stream) comprising a CO₂ amount of CO₂ gas to the first chamber; a water inlet for delivering a feedstock water characterized by a feedstock water pH to the first chamber; an acid inlet for adding an acid amount of an acid to the first chamber; a gas outlet for releasing an effluent CO₂-depleted/lean gas stream from the first chamber; and a first effluent outlet for releasing the water treated in the first chamber. In many embodiments, the acid amount is up to 10% of the CO₂ amount. In many embodiments, during the reactor's operation, the first chamber comprises a three-phase reaction medium, comprising a liquid, a solid, and a gas phases. In many such embodiments, the relative volumes of the phases of the three-phase reaction medium are adjusted as needed to optimize the reactor for a particular use. In many embodiments, the first chamber is a Fluidized Bed (FB) reactor, wherein the reaction medium is in a fluidized form. In many such embodiments, the first chamber further comprises a reaction medium solid inlet for delivering the reaction medium solid to the first chamber.

However, in many other embodiments, the first chamber is further split into sub-chambers for separate CO₂ absorption and conversion, as illustrated by FIG. 2B. In many such embodiments, the CO₂ absorption sub-chamber of the first chamber (an absorber) at least comprises: an implement for contacting gas and liquid phases; the gas inlet for delivering the CO₂-rich gas stream to the first chamber; the water inlet for delivering the water feedstock to the first chamber; the gas outlet for releasing the effluent lean gas stream from the first chamber, and an absorption effluent outlet for releasing a CO₂-enriched water stream from the CO₂ absorption sub-chamber. Furthermore, in many such embodiments, the CO₂ conversion sub-chamber of the first chamber (a converter) at least comprises: the reaction medium solid; an absorption effluent inlet in fluid communication with the absorption effluent outlet of the CO₂ absorption sub-chamber; and the first effluent outlet for releasing the water treated in the first chamber. In many such embodiments, the first chamber is a Packed Column (PC) reactor comprising: one or more packed columns comprising the reaction medium solid connected in parallel, wherein each packed column is the CO₂ conversion sub-chamber (the converter); the CO₂ absorption sub-chamber (the absorber); and a connector providing a fluid communication between the CO₂ absorption sub-chamber and the one or more packed columns, that is, between the absorption effluent outlet of the CO₂ absorption sub-chamber and the absorption effluent inlet of each of the one or more packed columns/CO₂ conversion sub-chambers. In many such embodiments, the acid inlet for adding the acid amount of the acid to the first chamber is situated in the connector, such that the acid is added to the first effluent (i.e., the water treated in the first chamber), prior to it entering the CO₂ conversion sub-chamber. However, in some other embodiments, the CO₂ conversion sub-chamber comprises the acid inlet for delivery of the acid to the CO₂ conversion sub-chamber. Furthermore, in some embodiments, the CO₂ absorption sub-chamber also comprises the acid inlet for delivery of the acid. In many embodiments, the converter also serves as a storage unit for the reaction medium solid of the reactor and no reaction medium solid is added during the reactor's operation.

In many embodiments, the reaction medium solid comprises a material or reagent selected from the group comprising (but not limited to): CaO; a carbonate, including CaCO₃ (limestone), further including its aragonite, calcite and vaterite forms, dolomite, and Na₂CO₃; NaHCO₃; a silicate, including MgSiO₃, olivine, pyroxene, mafic rock; another material capable of sequestering CO₂, and any combination thereof. In many embodiments, the acid is selected from the group comprising, but not limited to: a proton, including a proton obtained by electrochemically splitting water; and a strong acid, such as an acid with pKa of <2, including, for example, HCl, H₂SO₄, and any combination thereof.

In many embodiments, the second chamber at least comprises: an effluent inlet for delivery of the water treated in the first chamber and coming out of the first effluent outlet, a base inlet for delivery of a base amount of a base to the second chamber, and a second effluent outlet for release of the water treated and neutralized in the second chamber. In many embodiments, the base amount is up to 10% of the CO₂ amount. In many embodiments, the base is selected from the group comprising, but not limited to: an OH ion, including OH obtained by electrochemically splitting water; and a strong base, such as a base with pkb of >11, including, for example, NaOH, KOH, and any combination thereof. In many embodiments the base is a solid alkaline base. In many embodiments, the acid amount is equal to the base amount. In some embodiments, equimolar streams of the acid and the base are obtained via a water splitting method, wherein water is electrochemically split into hydrogen and hydroxide ions.

In some embodiments, the first chamber and the second chamber are both FB-type reactors, while in some other embodiments, the first chamber and the second chamber are both PC-type reactors. However, in some embodiments, the first chamber and the second chamber are independently selected to be one of: FB-type reactor, PC-type reactor, and any combination thereof.

In some embodiments, the reactor is installed on a ship or any other marine vessel. In many such embodiments, the movement of the ship or vessel facilitates and promotes the movement of water through the reactor, such that the ship or vessel itself serves as a water pump and no additional pump, or a lesser strength/lower power pump, is needed for the water flow through the reactor, affording significant energy and, therefore, costs savings. In many embodiments, the method utilizing the reactor described herein affords efficient and scalable storage of CO₂ in water in the form of robust bicarbonate ions, with minimal negative impact on the environment.

Accordingly, in many embodiments, the acid added to the first chamber (wherein CO₂ gas entering the reactor is received and adsorbed) enhances the otherwise slow kinetics of aqueous CO₂ conversion to carbonic acid, and, as such, promotes the storage of CO₂ in water by allowing the carbon to equilibrate with all inorganic carbon species dissolved in the water, and to afford formation of CO₂ storing bicarbonate ion. On the other hand, in many embodiments, the base added to the second chamber, receiving the effluent coming out of the first chamber, directly converts aqueous CO₂ that has escaped the first chamber (not having sufficient residence time to react with the reaction medium of the first chamber), to bicarbonate ion species in a fashion described by Equation 2 provided above, thereby returning the effluent leaving the reactor to its original, pre-reactor/feedstock pH value. In many embodiments, the addition of equivalent amounts of acid and base at different stages of the method utilizing the reactor described herein promotes the creation of bicarbonate ions from aqueous CO₂, and, as such, robust carbon storage, without netting any residual acid.

More specifically, FIGS. 2A and 2B schematically illustrate some examples of the reactor of many embodiments and methods of using thereof, wherein the first chamber is either the 3-phase, single stage Fluidized Bed (FB) reactor comprising a mix of CO₂-rich gas, water (seawater in this particular example), and the reaction medium solid (limestone alkaline solids in this particular example) (FIG. 2A); or the 2 sub-chamber/2 stage Packed Column (PC) reactor comprising the sub-chamber for CO₂ gas absorption into the effluent's water and the sub-chamber for CO₂ conversion to bicarbonate by the reaction medium solid (FIG. 2B). Here, the injection of the acid to this first chamber, and, in some embodiments, more specifically, pre-/to the second sub-chamber, promotes the conversion of CO₂(aqueous) to carbonic acid. In addition, the acid also affects the balance between gas adsorption and dissolution of the reaction medium's solids in the first chamber (or the second sub-chamber according to some embodiments). Furthermore, as also seen from FIGS. 2A and 2B, the second (base) chamber intakes the effluent coming out of the first chamber and mixes it with the stream of the base, wherein the rate/amount of base addition to the second chamber is equivalent to the rate/amount of acid addition to the first chamber. As such, the injection of the base increases the pH of the effluent stream leaving the first chamber, such that the effluent leaving the second chamber (i.e., the reactor) is characterized by a similar pH value to that of the water used as the feedstock to the reactor. Furthermore, it should be noted here, that CO₂(aqueous) will continue to equilibrate with carbonic acid and the rest of the DIC species even after the effluent leaves the reactor and mixes with the ambient sea/ocean water, and, that, therefore, in many embodiments, the steady-state pH of the effluent leaving the second chamber/reactor does not have to be exactly the same as the pH of the feedstock water to be safe for the environment. Accordingly, in some embodiments, the design and parameters of the reactor are optimized by changing the relative flow rates of the acid and the base compared to the CO₂ gas flow rate and the water flow rate for the effluent leaving the reactor to have a slightly higher pH than the feedstock water, such that the reactor released and fully equilibrated water eventually possesses the same pH as the ambient/feedstock water. On the other hand, in some embodiments, the effluent leaving the reactor has a slightly lower pH than the feedstock water, however, the mixing of the effluent with the ambient water makes such pH difference between the effluent/outflow and the ambient water negligible.

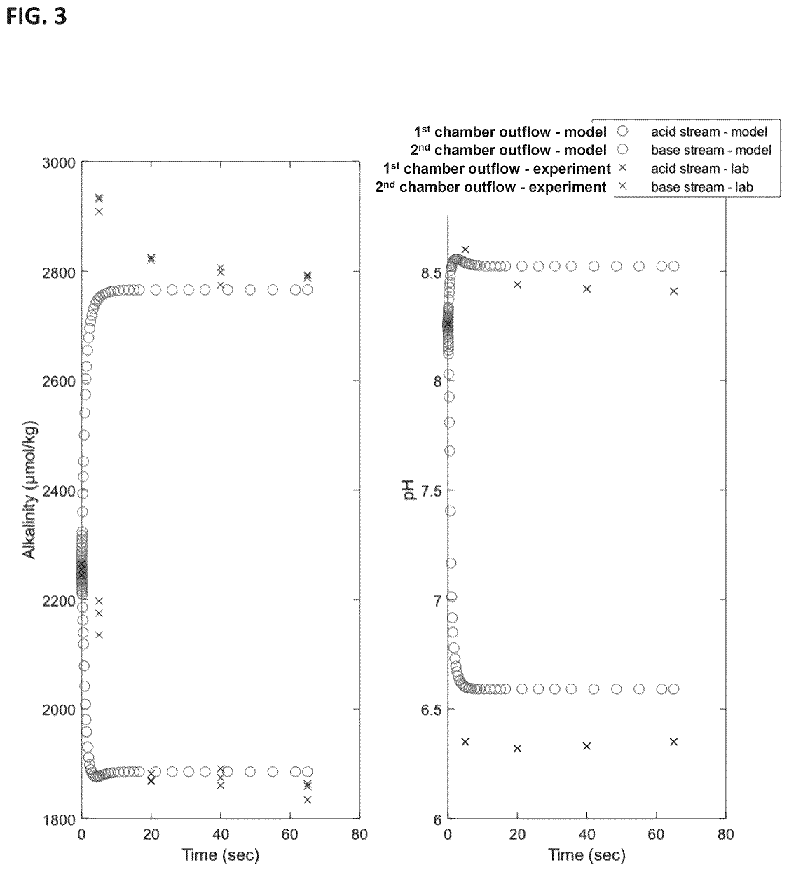

Furthermore, FIG. 3 provides and compares the alkalinity and pH data collected for a lab-built, scaled model of the reactor of many embodiments depicted in FIG. 2A. In these data collecting experiments, the first chamber was pre-loaded with the sufficient amount of CaCO₃ to afford a volume hold up of solid of 0.2% at a mean grain size of 150 microns, and a N₂ gas stream containing 5% CO₂ was bubbled into a 500 mL volume of artificial seawater entering the reactor, while the first chamber was actively stirred to ensure the bubbles and solids were fully turbulent in the water flowing through. Here, the artificial seawater was prepared by adding the major ions of ocean salinity, i.e., Na, K, Ca, Mg, CI, and SO₄²⁻ to water via their corresponding solid salts in a ratio matching modern seawater. Next, the artificial seawater moved into the first reaction volume/chamber at 1.5 mL/s alongside a 0.001376 mol/L solution of HCl moving at the same rate. Moreover, in the second chamber, the effluent from the first chamber was mixed with the base solution comprising 0.001393 mol/L NaOH at a rate of 1.8 mL/s. Notably, according to many embodiments, these values will scale up linearly as the size of the reactor is increased to accommodate more CO₂ gas flux from a post-combustion point source.

In addition, FIG. 3 compares the alkalinity and pH data obtained from these experiments to those from a corresponding computational model, wherein the figure's x-traces correspond to the experimental data collected over a period of approximately 1 hour, while the o-traces correspond to the computational model's output. As can be seen from this figure, at steady-state, the model and experimental data compare well. Also, notably, the model and experimental alkalinity values plots appear to fit better than the model and experimental pH values plots, which can be explained (although not to be bound by any theory) by the fact, that pH is much more sensitive (as compared to the computational model) towards true ‘tau’ value offsets than alkalinity. In turn, the pH offset is larger at lower pHs, because this is the steep part of the ‘tau’ response to pH (as can be seen in FIG. 1). Nevertheless, in many embodiments, a well calibrated computational model is used to study and optimize the sensitivity of various parameters to the overall reactor behavior prior to the reactor build and use.

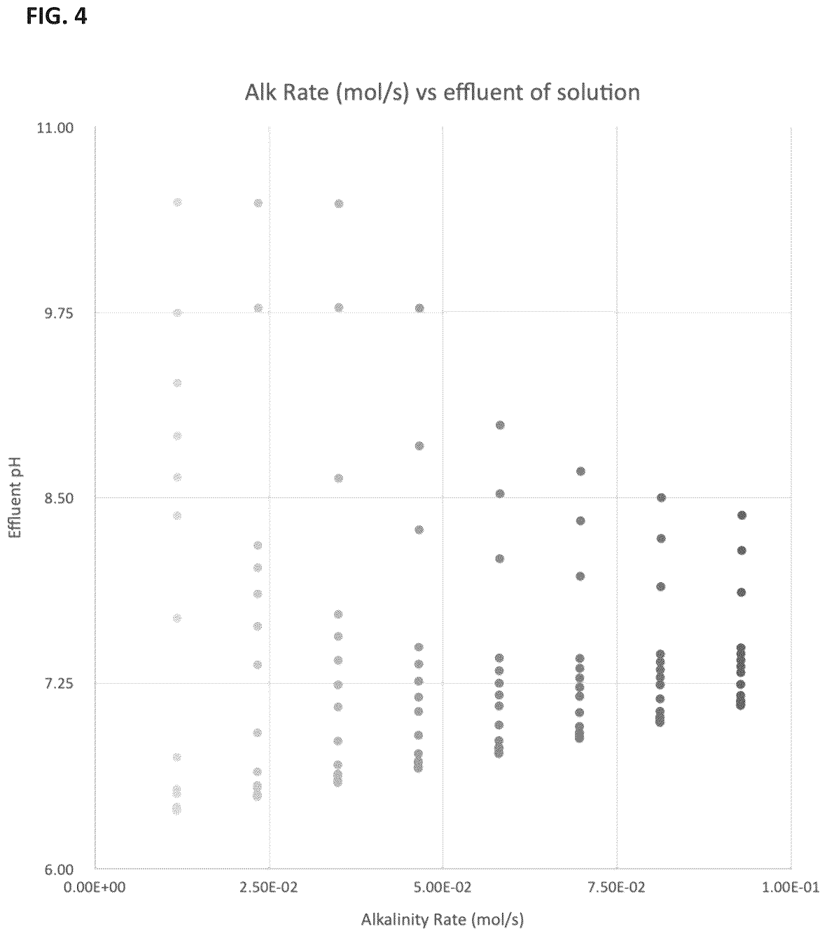

Moreover, FIG. 4 illustrates a model sensitivity study, conducted to determine how much base needs to be added to the second chamber, such that the pH of the effluent leaving the reactor is close to the pH of the feedstock water. More specifically, here, the alkalinity generation rate of the first chamber (x-axis) is plotted against the pH of the overall reactor's effluent (y-axis) for a range of base addition rates (dots), with the bottom dots representing zero base added (i.e., the first chamber's effluent alone), and the top dots representing the most added base (i.e., 30 mmol/sec in this particular example). Notably, the alkalinity generation rate is the same metric as the rate of carbon storage for the rector of many embodiments with a constant CO₂ gas flow rate, such that higher values on the x-axis are indicative of a more efficient overall system/rector for carbon storage by AWL (e.g., by the reactor of many embodiments abroad a marine vessel). As such, as seen from FIG. 4, and according to many embodiments, the alkalinity generation rate increases along the x-axis with more water flow through the first chamber, wherein, for example, according to the model, a flow increase from 5 to 40 liters/sec of seawater corresponds to a 10 to 90 mmol/s of alkalinity generation increase. Moreover, in many embodiments, larger flow rates of water lead to a higher pH in the effluent when no base is added to the second chamber. In addition, in many embodiments, the slower flow rates of water are more sensitive to the larger flow rates of base into the reactor. In many embodiments, the feedstock pH is 8.1.

As such, FIG. 4 demonstrates that, in many embodiments, for the first chamber with a larger alkalinity generation rate, the pH of the water leaving the second chamber (i.e., the pH of the overall reactor's effluent) is less sensitive to base addition in the second chamber, and that it also requires less base to achieve a given pH of the effluent. In other words, in many embodiments, at high alkalinity generation rates in the first chamber, the reactor's effluent is buffered to smaller ranges of pH for the same amount of base added in the second chamber. Accordingly, these model results illustrate the alkalinity and pH sensitivity of the reactor of many embodiments, and, according to many embodiments, provide a road map for operating any such acid-base addition system reactor, wherein the goal is to minimize the change in pH of the effluent relative to the feedstock water, while also maximizing the efficiency of CO₂ conversion to bicarbonate.

### DOCTRINE OF EQUIVALENTS

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

1. A reactor for CO₂ sequestration and storage in water, characterized by a neutral or near neutral pH outflow, at least comprising:
a first chamber comprising:
a reaction medium solid;
a gas inlet for delivering a gas stream comprising a CO₂ amount of CO₂ gas to the first chamber;
a water inlet for delivering a feedstock water characterized by a feedstock pH to the first chamber;
an acid inlet for delivering an acid amount of an acid to the first chamber;
a gas outlet for releasing an effluent gas from the first chamber; and
a first effluent outlet for releasing a first effluent, wherein the first effluent is the first chamber's liquid effluent; and
a second chamber, in fluid communication with the first chamber, wherein the second chamber at least comprises:
an effluent inlet, in fluid communication with the first effluent outlet for delivering the first effluent to the second chamber;
a base inlet for delivering a base amount of a base to the second chamber;
wherein the base amount is equimolar to the acid amount, and
a second effluent outlet for release of a second effluent, wherein the second effluent is the second chamber's and the reactor's liquid effluent.

2. The reactor of claim 1, wherein the first chamber is a fluidized bed reactor, and the first chamber further comprises a reaction medium solid inlet for delivering the reaction medium solid to the first chamber.

3. The reactor of claim 1, wherein the first chamber further comprises a CO₂ absorption sub-chamber and a CO₂ conversion sub-chamber connected in series via a connector for separate CO₂ absorption and conversion to bicarbonate.

4. The reactor of claim 3, wherein
the CO₂ absorption sub-chamber at least comprises:
an implement for contacting gas and liquid phases,
the gas inlet,
the water inlet,
the gas outlet,
optionally, the acid inlet, and
an absorption effluent outlet for release of a CO₂-enriched water from the CO₂ absorption sub-chamber;
the CO₂ conversion sub-chamber at least comprises:
the reaction medium solid,
an absorption effluent inlet in fluid communication with the absorption effluent outlet of the CO₂ absorption sub-chamber, and
the first effluent outlet; and
the connector at least comprises the acid inlet.

5. The reactor of claim 4, wherein the first chamber is a packed column reactor comprising: one or more packed columns connected in parallel, wherein each packed column is the CO₂ conversion sub-chamber; the CO₂ absorption sub-chamber; and a connector providing a fluid communication between the CO₂ absorption sub-chamber and each of the one or more packed columns.

6. The reactor of claim 1, wherein the feedstock water is water selected from the group consisting of: seawater, freshwater; and any combination thereof.

7. The reactor of claim 1, wherein the acid is selected from the group consisting of: a proton and an acid with pKa of <2.

8. The reactor of claim 7, wherein the acid is selected from the group consisting of: HCl, H₂SO₄, and any combination thereof.

9. The reactor of claim 1, wherein the base is selected from the group consisting of: an OH⁻ ion and a base with pkb of >11.

10. The reactor of claim 9, wherein the base is selected from the group consisting of: NaOH, KOH, and any combination thereof.

11. The reactor of claim 1, wherein the acid is a proton, the base is a hydroxide ion, and the acid amount and the base amount are obtained and delivered to the first and the second chambers, correspondingly, form a water splitting process, wherein the water splitting process splits water into hydrogen and hydroxide ions.

12. The reactor of claim 1, wherein the acid amount and the base amount are up to 10% of the CO₂ amount.

13. The reactor of claim 1, wherein the reaction medium solid comprises a material or reagent selected from the group consisting of: CaO; limestone and its various forms, including aragonite, calcite and vaterite; dolomite, Na₂CO₃, another carbonate; NaHCO₃; MgSiO₃, olivine, pyroxene, mafic rock; another silicate; another material capable of sequestering CO₂; and any combination thereof.

14. A method for CO₂ sequestration and storage in water, characterized by a neutral or near neutral pH outflow, comprising:
providing a reactor at least comprising:
a first chamber comprising:
a reaction medium solid;
a gas inlet for delivering a gas stream comprising a CO₂ amount of CO₂ gas to the first chamber;
a water inlet for delivering a feedstock water characterized by a feedstock pH to the first chamber;
an acid inlet for delivering an acid amount of an acid to the first chamber;
a gas outlet for releasing an effluent gas from the first chamber; and
a first effluent outlet for releasing a first effluent, wherein the first effluent is the first chamber's liquid effluent; and
a second chamber, in fluid communication with the first chamber, wherein the second chamber at least comprises:
an effluent inlet, in fluid communication with the first effluent outlet for delivering the first effluent to the second chamber;
a base inlet for delivering a base amount of a base to the second chamber;
wherein the base amount is equimolar to the acid amount, and
a second effluent outlet for release of a second effluent, wherein the second effluent is the second chamber's and the reactor's liquid effluent characterized by an effluent pH;
providing and delivering to the first chamber the gas stream, the feedstock water, and the acid;
providing and delivering to the second chamber the base; and replenishing the reaction medium solid as needed; and
flowing the feedstock water through the first chamber and the second chamber sequentially
to sequester and store CO₂ from the gas stream as bicarbonate ion, wherein the bicarbonate ion is released into the environment with the reactor's liquid effluent, and wherein the effluent pH is equal or near equal to the feedstock pH.

15. The method of claim 14, wherein the first chamber is a fluidized bed reactor, and the first chamber further comprises a reaction medium solid inlet for delivering the reaction medium solid to the first chamber.

16. The method of claim 14, wherein the first chamber further comprises a CO₂ absorption sub-chamber and a CO₂ conversion sub-chamber connected in series via a connector for separate CO₂ absorption and conversion to bicarbonate.

17. The method of claim 16, wherein
the CO₂ absorption sub-chamber at least comprises:
an implement for contacting gas and liquid phases,
the gas inlet,
the water inlet,
the gas outlet,
optionally, the acid inlet, and
an absorption effluent outlet for release of a CO₂-enriched water from the CO₂ absorption sub-chamber;
the CO₂ conversion sub-chamber at least comprises:
the reaction medium solid,
an absorption effluent inlet in fluid communication with the absorption effluent outlet of the CO₂ absorption sub-chamber, and
the first effluent outlet; and
the connector at least comprises the acid inlet.

18. The method of claim 17, wherein the first chamber is a packed column reactor comprising: one or more packed columns connected in parallel, wherein each packed column is the CO₂ conversion sub-chamber; the CO₂ absorption sub-chamber; and a connector providing a fluid communication between the CO₂ absorption sub-chamber and each of the one or more packed columns.

19. The method of claim 14, wherein the feedstock water is selected from the group consisting of: seawater, freshwater, and any combination thereof.

20. The method of claim 14, wherein the acid is selected from the group consisting of: a proton and an acid with pKa of <2.

21. The method of claim 14, wherein the base is selected from the group consisting of: an OH-ion and a base with pkb of >11.

22. The method of claim 14, wherein the acid is a proton, the base is a hydroxide ion, and the acid amount and the base amount are obtained and delivered to the first and the second chambers, correspondingly, form a water splitting process, wherein the water splitting process splits water into hydrogen and hydroxide ions.

23. The method of claim 14, wherein the acid amount and the base amount are up to 10% of the CO₂ amount.

24. The method of claim 14, wherein the reaction medium solid comprises a material or reagent selected from the group consisting of: CaO; limestone and its various forms, including aragonite, calcite and vaterite; dolomite, Na₂CO₃, another carbonate; NaHCO₃; MgSiO₃, olivine, pyroxene, mafic rock; another silicate; another material capable of sequestering CO₂; and any combination thereof.

25. A marine vessel capable of CO₂ sequestration and storage in water and characterized by a neutral or near neutral pH outflow, comprising:
a reactor at least comprising:
a first chamber comprising:
a reaction medium solid;
a gas inlet for delivering a gas stream comprising a CO₂ amount of CO₂ gas to the first chamber;
a water inlet for delivering a feedstock water characterized by a feedstock pH to the first chamber;
an acid inlet for delivering an acid amount of an acid to the first chamber;
a gas outlet for releasing an effluent gas from the first chamber; and
a first effluent outlet for releasing a first effluent, wherein the first effluent is the first chamber's liquid effluent; and
a second chamber, in fluid communication with the first chamber, wherein the second chamber at least comprises:
an effluent inlet, in fluid communication with the first effluent outlet for delivering the first effluent to the second chamber;
a base inlet for delivering a base amount of a base to the second chamber;
wherein the base amount is equimolar to the acid amount, and
a second effluent outlet for release of a second effluent, wherein the second effluent is the second chamber's and the reactor's liquid effluent.

26. The marine vessel of claim 25, wherein a movement of the marine vessel across a body of water facilitates and promotes flowing of the feedstock water through the reactor, such that the marine vessel serves as a water pump.
